(19) United States
(12) Patent Application Publication
(10) Pub. No.: US 2022/0027915 A1
(43) Pub. Date: Jan. 27, 2022

(54) SYSTEMS AND METHODS FOR PROCESSING TRANSACTIONS USING CUSTOMIZED TRANSACTION CLASSIFIERS

(71) Applicant: SHOPIFY INC., Ottawa (CA)

(72) Inventors: DAVID CAMERON, KITCHENER (CA); HANAN AYAD, Waterloo (CA)

(21) Appl. No.: 16/934,783

(22) Filed: Jul. 21, 2020

(51) Int. Cl. G06Q 20/40; G06N 20/00; G06Q 30/06

(52) U.S. Cl. CPC G06Q 20/4016; G06Q 30/0637; G06N 20/00

(57) ABSTRACT

An online service may use an online service platform to conduct transactions. An online service platform may have built-in transaction analysis, or may support third-party transaction analysis applications, that can assist in transaction processing by assigning classifications to transactions. However, automated rules-based transaction processing based on such classifications can be difficult to scale and manually analyzing transactions can be impractical when processing a large volume of transactions. Computer-implemented systems and methods for processing transactions using customized service-specific transaction classifiers are disclosed. The service-specific transaction classifiers are generated using service-specific machine learning models that are each trained based on historical transaction data for the corresponding online service. This functionality allows an online service platform, or third-party application, to provide personalized transaction classifications for conditioning the processing of transactions based on an online service's past transaction decisions.

### FIELD

The present application relates to transaction processing, and, more particularly, to conditioning processing of transactions on outputs of customized transaction classifiers.

### BACKGROUND

An online service may use an online service platform to conduct transactions. An online service platform may have built-in transaction analysis, or may support third-party transaction analysis applications, that can assist in transaction processing by assigning classifications to transactions, which may then be processed based at least in part on the assigned classifications. However, programming and maintaining rules for automated rules-based transaction processing based on such classifications can be difficult to scale as volume and/or diversity of an online service's product/service offerings, customer base and/or geographic presence increases. Moreover, manually analyzing even a small percentage of transactions can be impractical when processing a large volume of transactions. Computer-implemented systems and methods for processing transactions using customized service-specific transaction classifiers are disclosed. The service-specific transaction classifiers are generated using service-specific machine learning models that are each trained based on historical transaction data for the corresponding online service. This functionality allows an online service platform, or third-party application, to provide personalized transaction classifications for conditioning the processing of transactions based on an online service's past transaction decisions.

Therefore, it is desired to have computer-implemented methods and systems for improved transaction processing for online services.

### BRIEF DESCRIPTION OF THE DRAWINGS

Embodiments will be described, by way of example only, with reference to the accompanying figures wherein:

FIG. 1 is a block diagram of an e-commerce platform, according to one embodiment;

FIG. 2 is an example of a home page of an administrator, according to one embodiment;

FIG. 3 illustrates the e-commerce platform of FIG. 1, but including a transaction analysis engine according to one embodiment;

FIG. 4 illustrates a system for providing store-specific order fulfillment decision recommendations for merchants selling products on an e-commerce platform, according to one embodiment;

FIG. 5 illustrates an example merchant interface webpage for viewing orders for one store associated with a merchant account on an e-commerce platform;

FIGS. 6 to 8 illustrate example merchant interface webpages for viewing fraud analysis details for orders;

FIG. 9 illustrates steps of a computer-implemented method, according to one embodiment; and

FIG. 10 illustrates steps of a computer-implemented method, according to another embodiment.

### DETAILED DESCRIPTION

For illustrative purposes, specific example embodiments will now be explained in greater detail below in conjunction with the figures.

An online service platform through which an online service processes transactions may provide, or may support a third party application that provides, transaction classification functionality to facilitate transaction processing. For example, certain automated transaction processing functions may be conditioned based on the classifiers assigned by such transaction classification functionality. For example, a merchant may use a commerce platform (referred to herein as an e-commerce platform) to sell products or services to customers online. The products for sale by the merchant may be sold online via one or more online stores. In this example scenario, the online store(s) are examples of online services and the e-commerce platform is an example of an online service platform through which the online service (i.e., the online store) transacts. A merchant may manage multiple stores, each with its own separate inventory, orders, domain name (or subdomain), currency, etc. Order fraud is a common issue that merchants face. A transaction that is not authorized by a customer is referred to as fraudulent. A fraudulent transaction can result in a chargeback, which can cause a merchant to lose money. To try and mitigate this fraud risk, an e-commerce platform may have built-in fraud analysis, or may support third-party fraud analysis applications, that help bring suspicious orders to a merchant's attention. For example, the fraud analysis may assign a fraud risk level (e.g., low, medium, high) to each order. Put another way, orders, corresponding to purchase transactions, may be classified according to a projected fraud risk associated with a given purchase transaction.

In existing systems, in some cases, merchants may create automated workflows for processing orders that are identified as being low or medium risk. However, orders that are identified as being high risk are often analyzed manually by the merchant in order to eventually make a decision whether to fulfill or reject.

The decision whether to fulfill or reject an order that has been identified as high risk is an important one, because an incorrect decision can be costly. For example, approving an order that ultimately turns out to be fraudulent and results in a chargeback can be costly, but in many cases erroneously rejecting an order that was non-fraudulent may have an even higher ultimate cost because orders that are wrongly rejected due to suspected fraud, which is referred to as a “false positive”, can erode customer loyalty and may cause the affected consumer to avoid future business with the merchant connected with the erroneous rejection.

There are a number of potential reasons that a merchant may approve an order that has been assessed as having a high overall risk of fraud. For example, orders having billing and/or shipping addresses associated with a certain geographic location may be assessed as having a high overall risk of fraud based on historical fraud rates for all orders having billing and/or shipping addresses associated with that geographic location. However, an individual merchant may have fulfilled many non-fraudulent orders associated with that geographic location, and thus that merchant's past order fraud rate may diverge significantly from the overall rate of fraud for all orders associated with that geographic location. For example, Japan may be a geographic location that is generally associated with a high level of fraud risk for merchants based in the United States. As such, orders for U.S. based merchants having billing and/or shipping addresses in Japan may be flagged as having a high overall risk of fraud. However, a merchant specializing in particular merchandise, such as, for example, high-end sneakers, that is based in the United States may have fulfilled a number of non-fraudulent past orders to customers in Japan. As such, that merchant may therefore decide to approve orders from Japan even if they are flagged as having a high overall risk of fraud.

In practice, this means that the decision whether to fulfill or reject a particular order may be based on many other considerations aside from the computed fraud analysis across all orders on the platform. In terms of fraud risk tolerance, each merchant may make their own decision based on the level of risk they are willing to tolerate, in addition to other factors that even the merchants themselves may not be able to fully explain or rank in terms of relative importance in all scenarios. This is problematic for several reasons. For example, if responsibility for the manual fraud risk assessment at the merchant changes from one person to another, the knowledge the previous person developed in order to assess high risk orders may not be able to be accurately conveyed to the new person. Moreover, the time required to manually assess each high risk order can become too burdensome as the number of orders that need to be assessed increases, which can be problematic for merchants that process a large volume of orders every day.

It is desired to have a computer-implemented system and method that provides online service-specific transaction completion recommendations for use in determining whether to complete processing of a transaction. For example, such a system and method may allow completion of a transaction corresponding to an order received by a merchant to be conditioned on a service-specific transaction completion recommendation for that order based on factors such as, for example, an estimated fraud risk.

In some embodiments, the method involves deploying service-specific machine learning (ML) models that are trained to recommend transaction completion decisions that are intended to mimic the decisions that would otherwise be arrived at by the operator of the corresponding online service. For example, in the context of e-commerce and online stores, an individual ML model may be trained for each of multiple online stores by observing the historical data of high-risk orders that were flagged to the corresponding merchant and the eventual decision that was made by the merchant for that order (e.g., fulfill or reject). This functionality may allow an e-commerce platform, or third party application, to improve from providing an order fulfillment recommendation that is based only on a general fraud risk level, which may be only one of the criteria upon which a merchant may base an ultimate decision whether to fulfill or reject an order, to a more personalized fulfillment recommendation that is based on the individual merchant's past decisions. Further, in at least some cases such a personalized fulfillment recommendation may be employed in conditioning whether or not to automatically allow an order to proceed.

In one embodiment, a computer-implemented method includes receiving information regarding a transaction received by a particular online service, generating a first classification for the transaction based on the received information regarding the transaction information using a first ML model, and generating a service-specific classification for the transaction based on the received information using a second ML model. For example, the first ML model may be trained on a first data set containing historical transactions for multiple online services, and the second ML model may be trained on a second data set containing historical transaction data for the particular online service. The method may further include transmitting, for display on a device associated with the online service, classification information including at least the first classification and the service-specific classification for use in determining whether to complete processing of the transaction

In some embodiments, the service-specific classification generated for the transaction may correspond to a transaction completion recommendation for the transaction. For example, the transaction completion recommendation for the transaction may be one of a plurality of different transaction completion recommendations.

In some implementations, the plurality of different transaction completion recommendations may include at least an accept transaction recommendation and a reject transaction recommendation.

In some embodiments, the second data set containing historical transaction data for the particular online service may comprise data records containing transaction-related information for past transactions for the particular online service. For example, such data records may include, for each of the past transactions, information indicating whether the transaction was approved or rejected by the particular online service.

In some embodiments, the particular online service comprises a particular online store associated with a merchant account. For example, receiving information regarding a transaction received by the particular online service may comprise receiving order-related information for an order placed with the particular online store. In such embodiments, the first data set on which the first ML model is trained may contain historical order-related data for past orders for multiple online stores, and the second data set on which the second ML model is trained may contain historical order-related data for past orders for the particular online store. In some such cases, generating the first classification for the transaction may comprise generating, using the first ML model, a first classification for the order based on the received order-related information, and generating the service-specific classification for the transaction may comprise generating, using the second ML model, a store-specific classification for the order based on the received order-related information. In some such embodiments, transmitting classification information for the transaction may comprise transmitting, for display on a merchant device associated with the merchant account, classification information for the order, the classification information for the order including at least the first classification and the store-specific classification for use in determining whether to complete processing of the order.

In some embodiments, the first classification generated for the order may correspond to a fraud risk classification indicating a level of fraud risk for the order, the fraud risk classification for the order being one of a plurality of different fraud risk classifications that each correspond to a different level of fraud risk.

In some embodiments, the first data set containing historical order-related data for past orders for multiple online stores may comprise data records containing order-related information for the past orders for multiple online stores that are each tagged as either fraudulent or non-fraudulent.

In some embodiments, generating the store-specific classification for the order based on the received order-related information may comprise inputting the first classification for the order and at least a subset of the received order-related information into the second ML model.

In some embodiments, the second data set may be a subset of the first data set.

In some embodiments, the store-specific classification generated for the order may correspond to an order fulfillment decision. In such embodiments, the method may further comprise automatically processing the order in accordance with the order fulfillment decision indicated by the store-specific classification.

In some embodiments, the transaction completion recommendation for the transaction may correspond to an order fulfillment decision recommendation for the order. In such embodiments, the method may further comprise delaying processing of the order for a predetermined time period. In such embodiments, if no override of the order fulfillment decision recommendation is received within the predetermined time period, the order may be automatically processed in accordance with the order fulfillment decision recommendation after the predetermined time period has elapsed.

In some embodiments, transmitting the classification information may comprise transmitting the classification information for display, on a device associated with the particular online store, as part of a user interface that includes a user-selectable element corresponding to the transaction completion recommendation indicated by the service-specific classification. In some embodiments, the user-selectable element may be selectable to authorize the transaction completion recommendation indicated by the service-specific classification.

A system is also disclosed that is configured to perform the methods disclosed herein. For example, the system may include a memory to store information and at least one processor to directly perform (or instruct the system to perform) the method steps.

Example e-Commerce Platform

The methods disclosed herein may be performed in relation to an e-commerce platform. Therefore, an example of an e-commerce platform will be described.

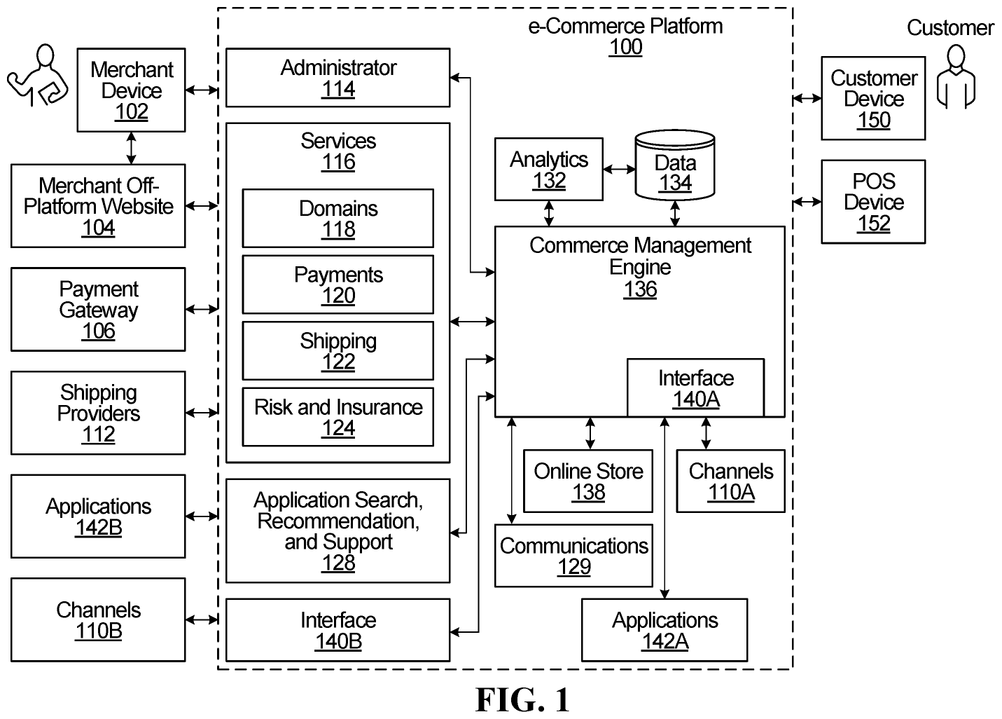

FIG. 1 illustrates an e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the platform 100. Merchants may utilize the e-commerce platform 100 for managing commerce with customers, such as by implementing an e-commerce experience with customers through an online store 138, through channels 110A-B, through point of sale (POS) devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform), and the like. However, even these ‘other’ merchant commerce facilities may be incorporated into the e-commerce platform, such as where POS devices 152 in a physical store of a merchant are linked into the e-commerce platform 100, where a merchant off-platform website 104 is tied into the e-commerce platform 100, such as through ‘buy buttons’ that link content from the merchant off platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store).

In some embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In some embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through/by POS devices, and the like). In some embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In some embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The client device web browser (or other application) then renders the page accordingly.

In some embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their website through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g. as data 134). In some embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

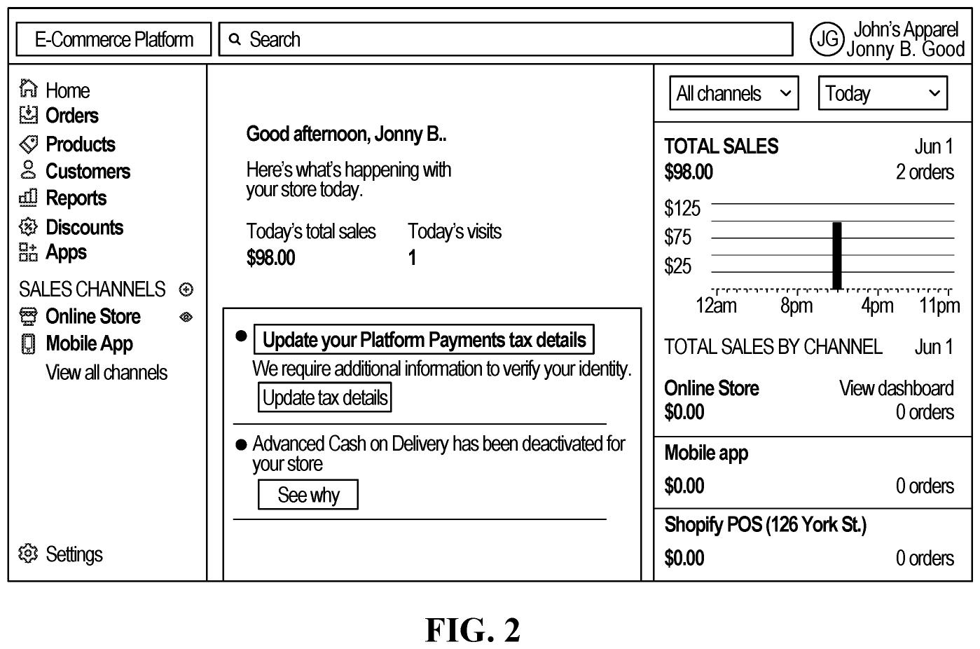

FIG. 2 depicts a non-limiting embodiment for a home page of an administrator 114, which may show information about daily tasks, a store's recent activity, and the next steps a merchant can take to build their business. In some embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In some embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g. via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for a communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's bank account (e.g., when using capital), and the like. These systems may have Sarbanes-Oxley Act (SOX) compliance and a high level of diligence required in their development and operation. The financial facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In some embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In some embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in some embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In some embodiments, an application 142A may be provided by the same party providing the platform 100 or by a different party. In some embodiments, an application 142B may be provided by the same party providing the platform 100 or by a different party. The commerce management engine 136 may be configured for flexibility and scalability through portioning (e.g., sharding) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which may utilize information from multiple online stores 138 to perform well. In some embodiments, rather than violating the isolation principle, it may be preferred to move these components out of the commerce management engine 136 and into their own infrastructure within the e-commerce platform 100.

In some embodiments, the e-commerce platform 100 may provide for a platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through application search, recommendations, and support 128. In some embodiments, core products, core extension points, applications, and the administrator 114 may be developed to work together. For instance, application extension points may be built inside the administrator 114 so that core features may be extended by way of applications, which may deliver functionality to a merchant through the extension.

In some embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension/API 140A-B, help make products easy to view and purchase in a fast growing marketplace. In some embodiments, partners, application developers, internal applications facilities, and the like, may be provided with a software development kit (SDK), such as through creating a frame within the administrator 114 that sandboxes an application interface. In some embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time.

In some embodiments, the e-commerce platform 100 may provide application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In some embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In some embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In some embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In some embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In some embodiments, the payment gateway 106 may accept international payment, such as integrating with leading international credit card processors. The card server environment may include a card server application, card sink, hosted fields, and the like. This environment may act as the secure gatekeeper of the sensitive credit card information. In some embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location.

An inventory component may record where variants are stocked, and tracks quantities for variants that have inventory tracking enabled. It may decouple product variants (a customer facing concept representing the template of a product listing) from inventory items (a merchant facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In some embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled.

A custom fulfillment service may send an email (e.g., a location that doesn't provide an API connection). An API fulfillment service may trigger a third party, where the third-party application creates a fulfillment record. A legacy fulfillment service may trigger a custom API call from the commerce management engine 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

Implementing a Transaction Analysis Engine in the e-Commerce Platform 100

In some cases, an order that has been placed with a particular online store through an e-commerce platform is assessed to determine a fraud risk level associated with the order. For example, the fraud analysis may assign a fraud risk level (e.g., low, medium, high) to each order. In some cases, merchants may create automated workflows for processing orders that are identified as being low or medium risk. However, orders that are identified as being high risk are often analyzed manually by the merchant in order to eventually make a decision whether to fulfill or reject. However, as discussed previously, manually reviewing orders to make order fulfillment decisions can be problematic and impractical for several reasons.

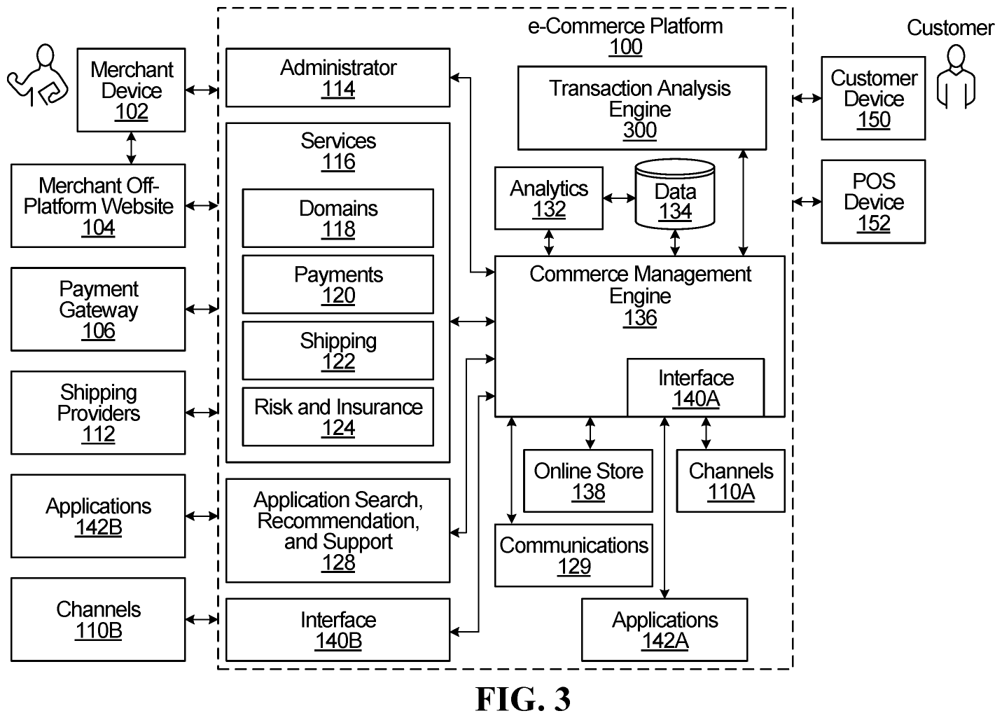

The e-commerce platform 100 of FIG. 1 can be configured to generate or otherwise determine fraud risk assessments and store-specific order fulfillment decision recommendations. FIG. 3 illustrates the e-commerce platform 100, but including a transaction analysis engine 200 for providing fraud risk assessments and store-specific order fulfillment decision recommendations. The transaction analysis engine 200 is an example of a computer-implemented system for providing customized classifiers for conditioning processing of transactions. In some cases, the transaction analysis engine 200 may be implemented by one or more general-purpose processors that execute instructions stored in a memory. Alternatively, some or all the functionality of the transaction analysis engine 200 may be implemented using dedicated circuitry, such as an application specific integrated circuit (ASIC), a graphics processing unit (GPU), or a programmed field programmable gate array (FPGA).

Although the transaction analysis engine 200 is illustrated as a distinct component of the e-commerce platform 100 in FIG. 3, this is only an example. A transaction analysis engine could also or instead be provided by another component of the e-commerce platform 100, such as the commerce management engine 136, or offered as a stand-alone component or service that is external to the platform 100. In some embodiments, either or both of the applications 142A-B provide a transaction analysis engine in the form of a downloadable app that is available for installation in relation to online stores associated with merchant accounts. The e-commerce platform 100 could include multiple transaction analysis engines that are provided by one or more parties. The multiple transaction analysis engines could be implemented in the same way, in similar ways and/or in distinct ways. In addition, at least a portion of a transaction analysis engine could be implemented on the merchant device 102. For example, the merchant device 102 could store and run a transaction analysis engine locally as a software application.

As discussed in further detail below, the transaction analysis engine 200 could implement at least some of the functionality described herein. Although the embodiments described below may be implemented in association with an e-commerce platform, such as (but not limited to) the e-commerce platform 100, the embodiments described below are not limited to the specific e-commerce platform 100 of FIGS. 1 to 3. Therefore, the embodiments below will be presented more generally in relation to any e-commerce platform. However, more generally, embodiments described herein do not necessarily need to be implemented in association with or involve an e-commerce platform.

### Generating Store-Specific Order Fulfillment Decisions

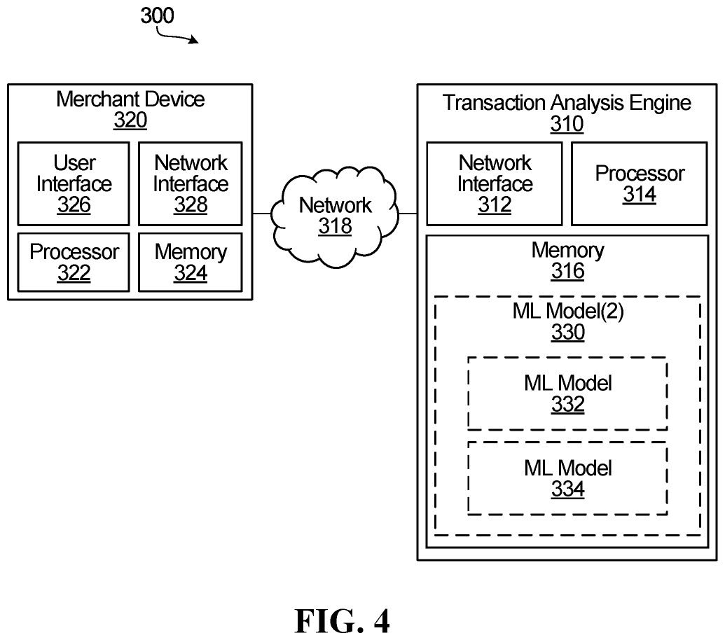

FIG. 4 illustrates a system 300 for generating store-specific order fulfillment decision recommendations for merchants, according to one embodiment.

The system 300 includes a transaction analysis engine 310. The transaction analysis engine 310 implements store-level data storage and a global-level data model for merchants. The transaction analysis engine 310 may be part of an e-commerce platform, e.g. e-commerce platform 100, similar to the transaction analysis engine 200 shown in FIG. 3. The transaction analysis engine 310 could also or instead be provided by another component of an e-commerce platform or implemented as a stand-alone component or service that is external to an e-commerce platform. In some embodiments, either or both of the applications 142A-B of FIG. 3 provide the transaction analysis engine in the form of a downloadable application that is available for installation in relation to a merchant account. In addition, at least a portion of the transaction analysis engine could be implemented on a merchant device, e.g. on merchant device 102 of FIG. 3 or on merchant device 320 described below. For example, the merchant device could store and run some or all of the transaction analysis engine 310 locally as a software application.

In many of the examples below, the transaction analysis engine 310 is assumed to be part of an e-commerce platform. However, as explained above, this is not necessary.

The transaction analysis engine 310 of FIG. 4 includes or has access to a network interface 312, a processor 314, and a memory 316. The network interface 312 is for communicating over network 318. The network interface 312 may be implemented as a network interface card (NIC), and/or a computer port (e.g. a physical outlet to which a plug or cable connects), and/or a network socket, etc., depending upon the implementation. The processor 314 directly performs, or instructs the transaction analysis engine 310 to perform, the operations of the transaction analysis engine 310 described herein, e.g. generating fraud risk classifications and order fulfillment decision recommendations, etc. The processor 314 may be implemented by one or more general purpose processors that execute instructions stored in a memory (e.g. in memory 316). The instructions, when executed, could cause the processor 314 to directly perform, or instruct the product data engine 310 to perform, any or all of the operations described herein. In other embodiments, some or all of the processor 314 may be implemented using dedicated circuitry, such as a programmed FPGA, a GPU, or an ASIC. In some embodiments, the memory 316 may include instructions and/or a data structure for implementing one or more ML models 330. For example, the one or more ML models 330 could include a first ML model 332 that has been trained on a first data set containing historical order-related data for multiple online stores associated with multiple merchant accounts and/or a second ML model 334 that has been trained on a second data set containing historical order-related data regarding a particular store's past fulfillment decisions, as discussed in further detail below. In some embodiments, the one or more ML models 330 may include multiple store-specific ML models, such as the store-specific ML model 334, each trained on a respective data set containing historical order-related data regarding the corresponding store's past fulfillment decisions. In some embodiments, the data set(s) on which the one or more ML models 330 are trained may be stored locally as part of transaction analysis engine 310, e.g., as part of memory 316, or they may be stored elsewhere in one or more databases of historical order-related data that may be accessed remotely by transaction analysis engine 310 to train the one or more ML models 330. The one or more ML models 330 could be implemented using any form or structure known in the art. Example structures for the one or more ML models 330 include but are not limited to: one or more artificial neural network(s); one or more decision tree(s); one or more support vector machine(s); one or more Bayesian network(s); and/or one or more genetic algorithm(s). The method used to train the one or more ML models 330 is implementation specific and is not limited herein. Non-limiting examples of training methods include but are not limited to: supervised learning; unsupervised learning; reinforcement learning; self-learning; feature learning; and/or sparse dictionary learning.

A plurality of merchants may access the transaction analysis engine 310 over the network 318 using merchant devices, e.g. to manage orders placed through online stores. For ease of explanation, only a single merchant device 320 is illustrated in FIG. 4. The merchant device 320 includes a processor 322, a memory 324, a user interface 326, and a network interface 328. The processor 322 directly performs, or instructs the merchant device 320 to perform, the operations of the merchant device 320 described herein, e.g. communicating with the transaction analysis engine 310 to receive and display order classification and fulfillment information on the user interface 326, instructing/authorizing order fulfillment decisions (e.g. based on merchant user input via user interface 326), etc. The processor 322 may be implemented by one or more general purpose processors that execute instructions stored in a memory (e.g. memory 324). The instructions, when executed, cause the processor 322 to directly perform, or instruct the merchant device 320 to perform, the operations described herein. In other embodiments, the processor 322 may be implemented using dedicated circuitry, such as a programmed FPGA, a GPU, or an ASIC. The user interface 326 may be implemented as a display screen (which may be a touch screen), and/or a keyboard, and/or a mouse, etc., depending upon the implementation. The network interface 328 is for communicating with the transaction analysis engine 310 over the network 318. The structure of the network interface 328 will depend on how the merchant device 320 interfaces with the network 318. For example, if the merchant device 320 is a mobile phone or tablet, the network interface 328 may comprise a transmitter/receiver with an antenna to send and receive wireless transmissions to/from the network 318. If the merchant device 320 is a personal computer connected to the network 318 with a network cable, the network interface 328 may comprise a network interface card (NIC), and/or a computer port (e.g. a physical outlet to which a plug or cable connects), and/or a network socket, etc.

In some embodiments, when an order is placed with a particular online store associated with a merchant account, transaction analysis engine 310 assesses the order to determine a fraud risk level associated with the order. For example, in some cases the fraud risk level may be one of a plurality of fraud risk levels that includes a low risk level, a medium risk level and a high risk level. Other fraud risk level rating schemes are possible. For example, in some implementations the fraud risk level may be expressed as a number, such as, for example, an integer number between 1 and 10 or between 1 and 100. In some cases, the associated fraud risk level of the order may be generated using a first ML model, such as the first ML model 332, which has been trained on a first data set containing historical order-related data for multiple online stores associated with multiple merchant accounts. In other words, in some cases the training of the first ML model based on the first data set may result in general fraud risk levels that are not specific to the particular store with which the order was placed and therefore may not correspond to that particular store's tolerance for fraud risk.

In one non-limiting example, training of the first ML model 332 involves accessing a database of historical order-related data to provide training data to the first ML model 332. For example, the training data may contain order-related records stored as order-related feature vectors that have been tagged as fraudulent or non-fraudulent. The database may include order-related records for a large number of online stores (potentially all stores) across an e-commerce platform. Non-limiting examples of order-related features might include order attributes such as information regarding the customer, the merchant, the institution that issued the payment instrument, time, billing address, delivery address, customer device information, IP address of customer device, currency of payment, and various other attributes regarding the order. In certain embodiments, a correlation between values of particular order-related features may be determined as part of the training. For example, certain patterns may be identified in the order-related feature values for the order-related records that are tagged as fraudulent. For example, multiple orders being placed within a certain time period in a specific geographic region having other attributes, such as a payment card not being present, may be identified as correlating with fraudulent activity. In some cases, the training of the first ML model 332 may identify these correlations and allow the transaction analysis engine 310 to generate, using the first ML model 332, fraud risk assessments for new orders by assessing whether, and to what degree, certain patterns that have been correlated with fraudulent activity are present in each new order.

In some cases, a variety of triggers or thresholds may be established based on the machine learning process. For example, the triggers may define certain threshold ranges in which orders that have those values tend to be fraudulent. When an order has multiple properties that fall within the threshold range, it may indicate that the order has a medium or high risk of being fraudulent. For example, the historical training data may show that orders placed with U.S. based merchants that originate in certain regions of Europe and have delivery addresses in certain regions of South America are correlated with fraudulent activity. The first ML model 332 may establish these ranges as triggering criteria in the assessment of fraud risk associated with a given order. A person of ordinary skill in the art will appreciate that there may be a wide variety of possible values on which it may be possible to distinguish fraudulent from non-fraudulent transactions. In one embodiment, the first ML model may be or may include a gradient boosting decision tree, an artificial neural network, a deep neural network and/or some other type of ML classifier. Accordingly, the disclosed embodiments are not limited to any particular type of fraud risk assessment model.

In certain embodiments, in addition to using the first ML model 332 to determine a fraud risk level associated with an order that was placed with a particular merchant, the transaction analysis engine 310 may also generate order fulfillment decision recommendation regarding fulfillment of the order based on historical data regarding that particular merchant's past fulfillment decisions. Put another way, the transaction analysis engine 310 may classify the transaction associated with a particular order on the basis of whether or not fulfilment of that order is recommended and, potentially, to as to a certainty or strength or that recommendation, the result of that classification being a decision recommendation. In some cases, the decision recommendations may be generated using a store-specific ML model, such as second ML model 334, which has been trained to mimic the fulfillment decisions of the particular merchant based on past fulfillment decisions made by that particular merchant. For example, the second ML model 334 may be a store-specific ML model 334 trained on a data set containing historical data records regarding that particular merchant's past fulfillment decisions to either accept or reject past orders.

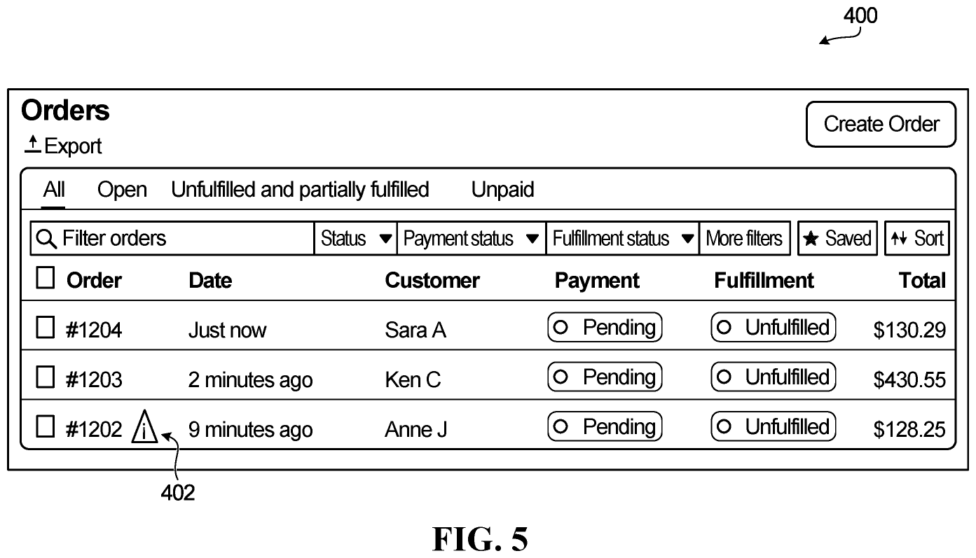

For example, merchant device 320 may be associated with a merchant account that is associated with a particular store, and when an order is placed through the particular store, the transaction analysis engine 310 may generate a fraud risk level or classification for the order using the first ML model 332 that has been trained on a first data set containing historical order-related data that is not specific to the particular store with which the order was placed, and may also generate a store-specific order fulfillment decision recommendation to either accept or reject the order using the second ML model 334 that has been trained on a second data set containing historical order-related data regarding past fulfillment decisions for that particular store. In some embodiments, the fraud risk level and/or the order fulfillment decision recommendation for the order may be transmitted by the transaction analysis engine 310 to the merchant device 320 via network 318 as part of classification information for the order. The classification information from the transaction analysis engine 310 may be displayed on the user interface 326 of merchant device 320, e.g., as part of an order fraud analysis interface as discussed later with reference to FIGS. 5-8.

In some embodiments, the first ML model 332 may be a common first ML model 332 that is used to generate fraud risk levels for orders for multiple stores, and second ML model 334 may be one of multiple individual store-specific second ML models that are each used to generate order fulfillment decision recommendations for an individual corresponding store.

In some cases, the first ML model 332 and the second ML model 334 may be implemented by separate ML components. In some cases, the first ML model 332 and the second ML model 334 may be implemented as a single ML component that produces two outputs. For example, the outputs of the first and second ML models may instead be the outputs of a single multi-output ML model which accepts the inputs of both models and produces two outputs, one corresponding to the output of the first model and the other corresponding to the output of the second model.

In one embodiment, the second ML model 334 may be or may include a gradient boosting decision tree, an artificial neural network, a deep neural network and/or some other type of ML classifier. Accordingly, the disclosed embodiments are not limited to any particular type of ML model to generate fulfillment decision recommendations.

In one non-limiting example, training an individual store-specific second ML model, such as the second ML model 334, to generate merchant-specific fulfillment decision recommendations for a particular merchant involves accessing a database of historical order-related data for the merchant to provide training data to the ML model. For example, the training data may contain order-related records stored as order-related feature vectors that have been tagged as being approved or rejected and have also been tagged with an assessed fraud risk level. If such a database of historical order-related data is not available for the store, then the training data set may be compiled over time as the merchant associated with the store approves or rejects orders, and the training can be done once a data set that is sufficiently large for training purposes has been compiled. In some cases, training may continue on an ongoing or periodic basis as new fulfillment decisions by the merchant are added to the data set. Past order fulfillment decisions in which the merchant ultimately made a decision that diverges from the decision that would otherwise be suggested by the assessed fraud risk level may be of particular importance to the training of the store-specific ML model, e.g., decisions in which the merchant approved an order despite the order having been assessed as having a high risk of fraud, or decisions in which the merchant rejected an order despite the order have been assessed as having a low risk of fraud.

As noted above, by deploying an individual ML model for each merchant or store and training each individual ML model based on the merchant's historical fulfillment decisions, the individual ML model for each store can be trained to generate fulfillment decision recommendations that mimic the merchant's historical fulfillment decisions, and thus may be able to accurately predict the merchant's fulfillment decisions for new orders.

In some embodiments, the transaction classifications (decision fulfillment recommendations) generated by the transaction analysis engine 310, e.g., using the store-specific ML model 334 that has been trained for a particular store, may be automatically executed, i.e., a fulfillment decision recommendation that recommends an order be rejected may automatically cause the order to be rejected and/or a fulfillment decision recommendation that recommends an order be accepted may automatically cause the order to be accepted. In this way, execution of transactions (orders) may be conditioned on the classifications thereof.

In some cases, the automatic action may not be completed until a specific period of time has passed, e.g., 24 hours. This type of delay may serve to provide the merchant with an opportunity to review a recommendation and decide whether to manually override it before it is automatically completed. However, delays in order processing may be perceived by consumers as negatively impacting the user experience, and therefore there may be a trade-off between providing a high user experience and minimizing fraud risk. For example, for some merchants it may be preferable to process orders quickly so that accepted orders are fulfilled quickly in order to provide a high quality user experience, even if doing so comes with an elevated fraud risk.

In some cases, the automatic accept/reject functionality (whether with or without a delay time period) may be selectively activated/deactivated by the merchant. For example, in some cases a merchant may not initially fully trust the fulfillment decision recommendations, and may prefer to start with a “human-in-the-loop” mode of operation, whereby the fulfillment decision recommendations generated by the transaction analysis engine 310 are made available to the merchant but not automatically acted upon. For example, transaction analysis engine 310 may transmit a fulfillment decision recommendation to a merchant device for display on a user interface of the merchant device, such as the user interface 326 of merchant device 320. The user interface of the merchant device may prompt the merchant for permission to carry out the recommended action. Over time, as instances of disagreement between the merchant and the fulfillment decision recommendations drop, an automated mode of order fulfillment decision processing may be enabled in which the fulfillment decision recommendations generated by the transaction analysis engine 310 are automatically acted upon. In some embodiments, the automated mode may be enabled once the percentage of disagreements between the merchant and the fulfillment decision recommendations drops below a particular threshold. For example, once the percentage of disagreements drops below the threshold, the merchant may be prompted to authorize the automated mode of order fulfillment decision processing.

As noted above, in some embodiments the general fraud risk assessment generated by the transaction analysis engine 310 may classify the fraud risk associated with a given order as being one of a finite set of classifications, such as low risk, medium risk and high risk. In such implementations, it has been observed that merchants often create automated rule-based processes for processing orders that have been assessed as being low risk or medium risk, but process high risk orders manually. In some implementations, an orders list may be displayed as part of a user interface on a merchant's device in which any order(s) flagged as being unusual in some way that may be of interest to the merchant may be distinguished in some way from other orders in the list.

FIG. 5 shows an example of such an order list 400 for a particular store. The order list 400 includes three pending orders, of which one order (order #1202) has been marked with a caution symbol 402, which in this example indicates that the order has been flagged as having a high risk for fraud. For example, referring again to FIGS. 1-3, the order list 400 is an example of an order list that may be accessible to a merchant through the “Orders” element in the sidebar of the administrator homepage as shown in FIG. 2, which the merchant may login to through a merchant device to manage aspects of their online store. In some embodiments, the caution symbol 402 may have been caused to be displayed on the order list 400 based on the order classification information generated by the transaction analysis engine 310.

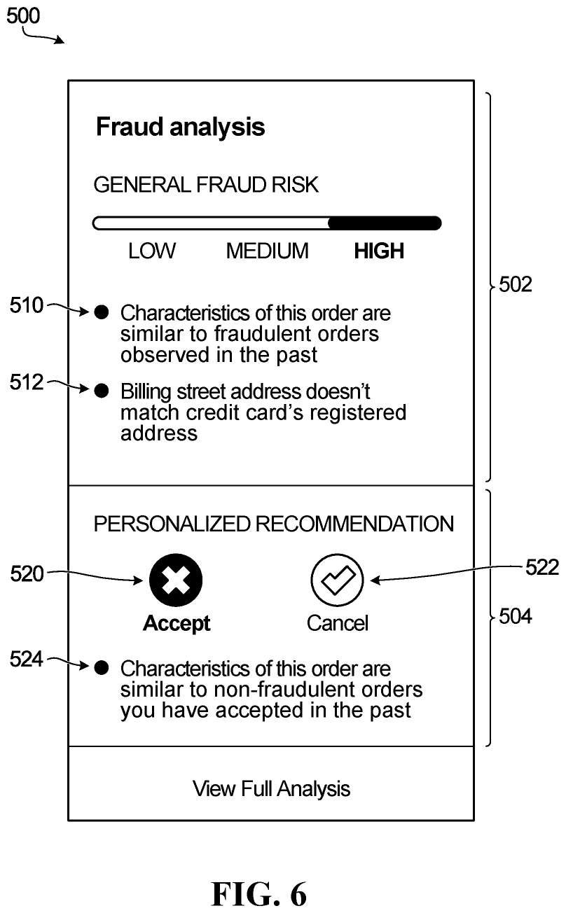

In some embodiments, the fulfillment decision recommendation for an order may be displayed together with the general risk assessment level or classification as part of a fraud analysis user interface on a merchant device. FIG. 6 shows one example of such a fraud analysis user interface 500. For example, in some implementations the caution symbol 402 in the order list 400 shown in FIG. 5 may be a user selectable “button” that, when selected, launches the fraud analysis user interface 500 shown in FIG. 6. The fraud analysis user interface 500 includes a general fraud risk assessment 502 and a personalized order fulfillment decision recommendation 504. In the example shown in FIG. 6 the general fraud risk assessment 502 indicates the order has been flagged as high risk for chargeback due to fraud. Moreover, the general fraud risk assessment 502 includes additional indicators 510, 512 that provide additional information to the merchant about the reasons for the assessed fraud risk level. In this case, the two indicators 510, 512 indicate that the order has been assessed as high-risk because the characteristics of the order are similar to fraudulent orders observed in the past, and more particularly that the billing street address doesn't match the registered billing address for the credit card that was used for payment.

As noted above, the fraud analysis user interface 500 shown in FIG. 6 also includes a personalized fulfillment decision recommendation that was generated by a ML model trained on a data set containing historical order-related data including the merchant's past order fulfillment decisions. For example, the fulfillment decision recommendation 504 may have been generated by transaction analysis engine 310 using the second ML model 334 of FIG. 4. In the example fraud analysis user interface 500 shown in FIG. 6, the fulfillment decision recommendation 504 recommends accepting the order. In this example, the fulfillment decision recommendation 504 includes an Accept icon 520 and a Cancel icon 522, and the recommendation to accept the order is conveyed by highlighting the Accept icon 520 so that it is more prominent and greying out the Cancel icon 522 so that it is less prominent. Moreover, in this case, the fulfillment decision recommendation 504 includes an indicator 520 that indicates that one reason to accept the order is that characteristics of the order are similar to non-fraudulent orders the merchant approved in the past.

In some embodiments, the Accept icon 520 and the Cancel icon 522 shown as part of the personalized fulfillment decision recommendation 504 of the fraud analysis user interface 500 are user-selectable “buttons” that are selectable to authorize the corresponding action, i.e., accepting or rejecting the order. In other embodiments, the Accept and Cancel icons 520 and 522 may merely be information elements indicating the recommendation generated by the transaction analysis engine and the associated action may be carried out automatically and/or be authorized through user selection via a different mechanism or user interface.

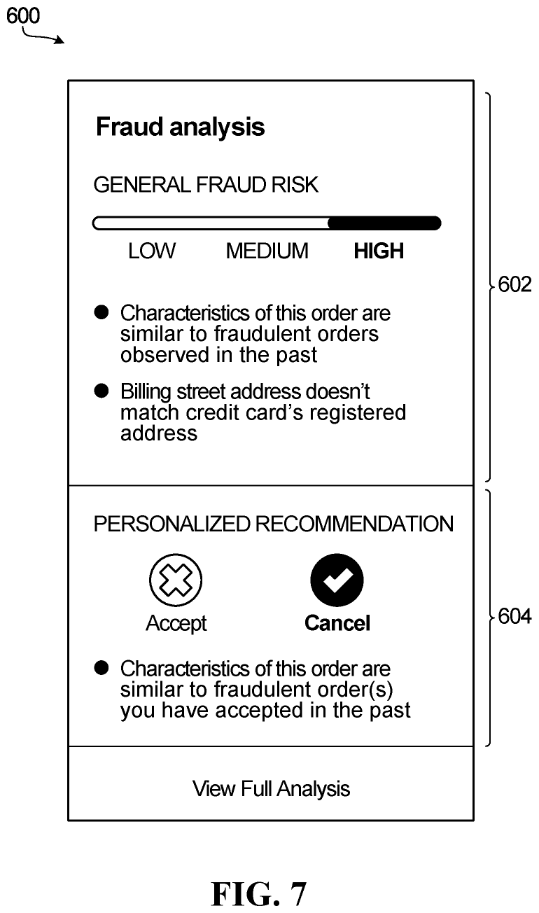

Referring again to FIG. 4, in some implementations, the training data set for the store-specific ML model 334 may be updated to include data for new orders that are received and accepted or rejected by the merchant account associated with the corresponding store. If a new order is approved and fulfilled, but turns out to be fraudulent, that outcome may be incorporated into the training data, so that the store-specific ML model 334 can be trained to avoid recommending fulfilling similar future orders. For example, FIG. 7 shows another example of a fraud analysis user interface 600 for a merchant device that, similar to the fraud analysis user interface 500 shown in FIG. 6, includes a general fraud risk assessment 602 indicating an order has been flagged as high risk for fraud but, unlike the fraud analysis user interface 500 shown in FIG. 6, the fraud analysis user interface 600 includes a personalized fulfillment decision recommendation 604 that recommends that the order be canceled because characteristics of the order are similar to fraudulent order(s) the merchant approved in the past. This type of recommendation may assist the merchant to avoid making the same mistake again if the merchant has manually approved a past order that was flagged as high-risk and ultimately proved to be fraudulent.

In some embodiments, the store-specific ML engine corresponding to a particular store may be trained/configured to learn from fulfillment decisions (both its own and those made manually by the merchant) that turned out to be wrong (e.g., an approval of a fraudulent order and/or a rejection of a non-fraudulent order). For example, in some embodiments additional information may be included in the training set(s) for the first (general) ML model or the second (store-specific) ML engine in order to allow the second ML engine to learn from past fulfillment decisions that were erroneous. For example, in some implementations the data set on which the second ML engine is trained may contain historical order-related data records for past orders processed by the particular online store that are each tagged as being an accepted or a rejected order, as well as being tagged as fraudulent or non-fraudulent. The second ML engine may then be trained on the second data set to avoid repeating past order processing decisions that were erroneous. This may allow the second ML engine to not only avoid repeating erroneous past order processing decisions, but also to identify when a current order processing decision differs from an erroneous past order processing decision. For example, this may allow the second ML engine to provide additional information or indicator(s) when providing an order processing decision/recommendation. For example, a recommendation to reject a current order may be accompanied by a message indicating that the rejection is being recommended because the order is similar to past order(s) that were approved by the merchant but turned out to be fraudulent. On the other hand, a recommendation to approve a current order may be accompanied by a message indicating that the approval is being recommended because the order is similar to past order(s) that were rejected by the merchant but turned out to be non-fraudulent.

The orders list 400 shown in FIG. 5 is one example of how a merchant may be notified that there may be something about an order that may be relevant to order processing. In some implementations, a notification, such as a text message, e-mail or some other form of electronic message may be sent to the merchant when a new order has been assigned a classification such as high-risk for fraud that may impact whether or not the order is approved for fulfillment.

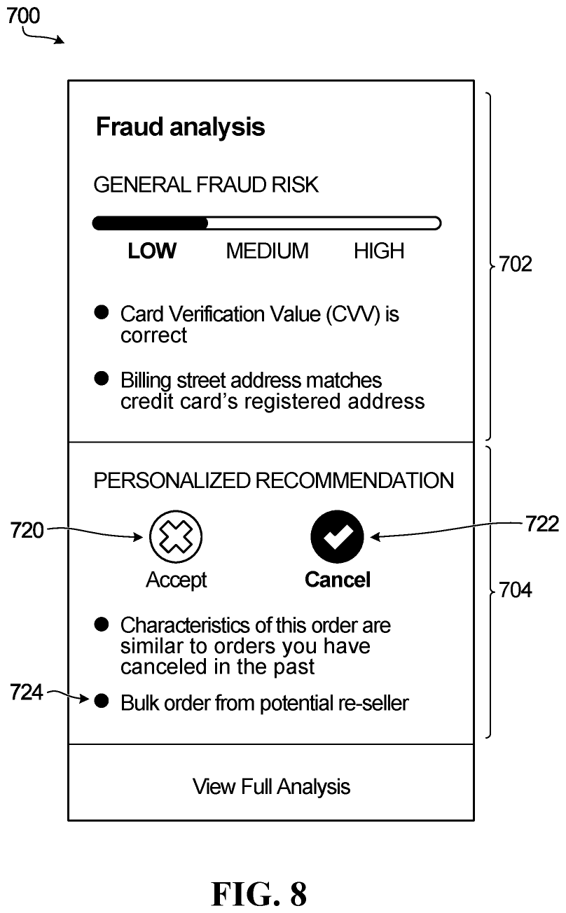

Risk of chargebacks due to fraud is not the only reason a merchant may decide to cancel an order. For example, a merchant may have a relationship with certain re-sellers or distributors that the merchant is willing to accept bulk orders from, but otherwise the merchant may wish to prevent other customers from purchasing bulk orders of items for the purposes of re-selling. FIG. 8 shows an example of a fraud analysis user interface 700 for display on a merchant device, such as merchant device 320 of FIG. 4, which includes an order fulfillment recommendation 604 that recommends cancelling an order not because of its assessed fraud risk, which in this example is indicated to be low in a general fraud risk assessment 702 portion of the user interface 700, but because characteristics of the order are similar to orders the merchant has canceled in the past. In particular, the personalized fulfillment decision recommendation 704 in this example has a greyed-out Accept icon 720 and a highlighted Cancel icon 722 indicating the recommendation is to cancel the order, as well as a first indicator 722 indicating characteristics of the order are similar to orders the merchant has canceled in the past and a second indicator 724 indicating that the order appears to be a bulk order for re-sale purposes.

As noted earlier, it has been observed that a merchant's decision whether to fulfill or reject a particular order may be based on many other considerations aside from fraud analysis. The examples shown in FIGS. 6 and 8 above are consistent with this observation. In particular, the personalized fulfillment decision recommendations 504 and 704 of FIGS. 6 and 8 differ from the fulfillment decisions that would otherwise be suggested by the general fraud risk assessments 502 and 702 of those examples.

The above examples of taking into account other considerations beyond fraud example serves to illustrate how transaction classifications made by the transaction analysis engine 310 may extend beyond fraud assessment/classification. Indeed, in some implementations, classifications made by the transaction analysis engine 310 may, additionally or alternatively, take into account one or more other considerations/factors beyond or even instead of fraud such as, for example, as in various examples variously provided herein.

In some embodiments, the data set used to train a store-specific ML model to generate store-specific fulfillment decision recommendations may include store-specific data. For example, rules or filters that a merchant has created for order processing in order to override automated fulfillment decision processes based on fraud risk assessments may be used as training data to train the store's individual store-specific ML model to generate store-specific fulfillment decision recommendations. Examples of such rules or filters could include such things as an accept list of consumers for whom the merchant wishes to approve orders regardless of the assessed fraud risk and/or a block/reject list of consumers for whom the merchant wishes to reject orders regardless of the assessed fraud risk. Such lists may include one or more pieces of identification information for each consumer on the list, such as email addresses, postal codes, device IDs, etc. Such lists are often created/updated reactively by a merchant in response to either a positive or negative experience with a particular customer. For example, a merchant may add a customer to a “block/reject list” after receiving a chargeback due to fraud for a past order from that customer. However, the feedback from the merchants in this type of workflow scenario is merely reactive, as opposed to looking at the original order and considering why that order ended up going wrong. In contrast, by training a store-specific ML model based on a training set that includes such list(s) and order-related details associated with the orders that resulted in certain customers being added to the list(s), the store-specific ML model may be trained to learn why a particular entry was added to a specific list. As such, the trained store-specific ML model may be trained to identify when a new order has characteristics similar to past order(s) corresponding to one or more entries in the merchant's accept list or block/reject list, and proactively recommend that the new order be accepted/rejected on that basis.

In this way, certain embodiments of the present disclosure can leverage a merchant's accept list or block/reject list to inform fulfillment decisions for orders from customers that are not included on the merchant's accept list or block/reject list, whereas the use of such lists in conventional order processing automation is typically limited to expediting processing of orders for the customers included in such lists.

It has been observed that in some cases a merchant's fulfillment decisions may be context dependent. That is, in some cases a merchant may decide to accept one order received in a first context and decide to reject another substantially similar or even identical order in another context. For example, in some cases a merchant's tolerance for fraud risk may be lower during a sale event, such as a flash sale in which one or more items are offered at a significant discount for a relatively short period of time. During such sales, demand for the item(s) that are included in the flash sale is typically high, and thus the merchant may be more inclined to cancel an order for a sale item if the order has been flagged as a fraud risk. One reason a merchant may do this is because cancelling such an order may place the ordered item back into stock while the flash sale is still ongoing, thereby making it available for purchase by another low fraud risk customer during the sale while demand for the item is high. In contrast, under non-sale conditions that same merchant may be relatively less likely to cancel an order even if it has been flagged as a fraud risk.

In some embodiments, the order-related information associated with the order fulfillment decisions that are included in the training data set used to train the merchant's ML model may include information identifying particular contexts in which the particular order fulfillment decisions were made by the merchant. In such embodiments, the merchant's ML model may be trained to mimic the merchant's context dependent order fulfillment decisions. For example, in some embodiments, the training data set used to train a merchant's ML model may include prior order fulfillment decisions for flash sale orders and the order-related information associated with those order fulfillment decisions may include information identifying them as being order fulfillment decisions for flash sale orders.

In some embodiments, rather than training the merchant's ML model to mimic the merchant's order fulfillment decisions in a particular context, the e-commerce platform may be configured to process orders associated with that particular context in a predetermined way (e.g., independent of the order fulfillment decision recommendation generated by the merchant's ML model), and orders received in other contexts may be subject to the order fulfillment decision recommendations of the merchant's ML model as described previously.

For example, in some embodiments the e-commerce platform may be configurable by the merchant to automatically reject orders received during a flash sale that are assessed as having a threshold level of fraud risk. For example, the merchant may configure the e-commerce platform for a flash sale such that during the flash sale any order for sale item that is assessed as having a high fraud risk level is automatically canceled and the sale item is returned into the available stock for the sale. In some cases, this configuration by the merchant for the flash sale may override or bypass the fulfillment decision recommendation generated by the merchant's ML model that has been trained based on the merchant's past order fulfillment decisions. In some cases, the training data set used to train the merchant's ML model may exclude order fulfillment decisions for orders that were subject to a flash sale.

In some embodiments, a merchant is able to configure the e-commerce platform such that order fulfillment decisions for one or more items or services offered for sale by the merchant through the e-commerce platform are automated based on the order fulfillment decision recommendations generated by the merchant's trained ML model as described previously, while order fulfillment decisions for other item(s) or service(s) offered for sale by the merchant through the e-commerce platform may be made by some other means, e.g., automatically on the basis of static rules/decision trees and/or manually subject to review by the merchant.

In many of the example embodiments described above, the store-specific ML model corresponding to a particular store is leveraged to provide order classification/processing functionality that occurs after an order has been received. In other embodiments, store-specific ML models could be utilized at an earlier stage in the order placement process, such as when a customer attempts to add items to or otherwise edit a virtual shopping cart and/or when attempting to checkout. More generally, the fraud analysis functionality described herein could be done at different stages of the ordering process, including, but not limited to: 1) after checkout is completed (order received, pre-authorization or hold completed but before fulfillment and actual transaction completed); 2) after fulfillment (e.g. order received, and designated as fulfilled (shipping label generated and/or request sent to fulfillment service), and actual transaction is completed); and 3) before the order is received (before checkout). For example, a check may be done by a particular store's trained ML model during the checkout process (but before the order is placed) to determine if, based on the information available to the store-specific ML model at that time, the order will be (or is likely to be) rejected. If so, in some embodiments the checkout process may be adapted based on the determination. For example, the available payment options might be adapted by removing certain payment options that are more commonly associated with fraud or by requiring multi-factor authentication. In this manner, the merchant may be able to avoid receiving an order that is likely to ultimately be rejected, while offering checkout options that would likely result in approval of the order. On the other hand, if the ML model determines that the order will be (or is likely to be) accepted, then further payment options that might otherwise be riskier to the merchant could be made available. In this way, the checkout process for orders that are assessed to be less likely to be rejected can potentially be adapted to provide a higher user experience (made simpler/easier with more options), and orders assessed to be more likely to be rejected can potentially be revised in a manner that increases the likelihood that the order will be accepted. In other embodiments, the payment options would not necessarily change but the fraud analysis could be done if there are sufficient signals to identify and correlate the buyer/customer with prior approval/rejection decisions made by the merchant. Examples of orders that may be so revised include orders associated with a buyer identifiable based on IP address, location, a platform login, etc. and who previously originated bulk orders that have been rejected in the past and who is in the process of building a cart with a bulk order.

### Methods

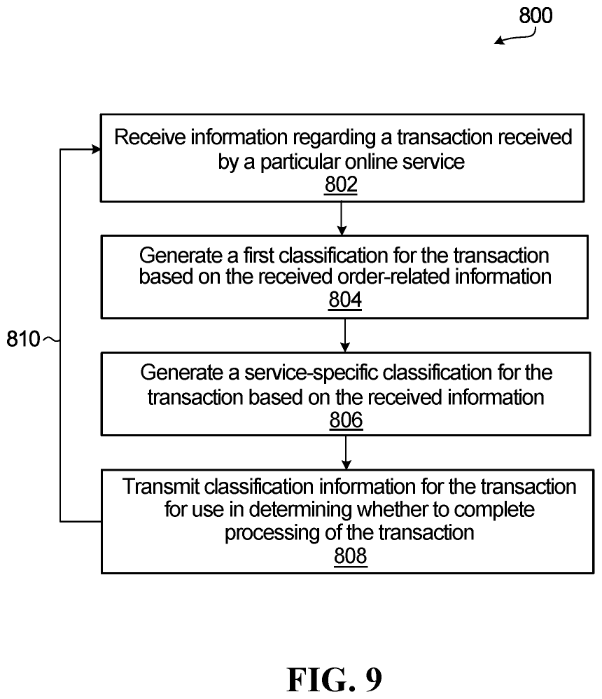

FIG. 9 illustrates a computer-implemented method 800, according to one embodiment. The method 800 may be performed by a computing device (e.g. a processor or combination of processors such as the processor 314 in transaction analysis engine 310). The computing device may be in an online service platform, such as the e-commerce platform 100 of FIG. 3, or maybe a stand-alone component or service that is external to an online service platform. In some embodiments, at least a portion of the computer-implemented method could be implemented on a device associated with a particular online service, such as, for example, the merchant device 102 of FIG. 2 or the merchant device 320 of FIG. 4. The method will be described as being performed in/by the transaction analysis engine 310 of FIG. 4, but this is not necessary.

At step 802 of FIG. 9, the transaction analysis engine 310 receives information regarding a transaction received by a particular online service. The online service may be a particular online store associated with a merchant account, for example. The information regarding the transaction may be received from different locations depending on where the transaction analysis engine 310 is implemented. For example, if the transaction analysis engine 310 is implemented as part of an e-commerce platform, then the order-related information may be received from another component of the e-commerce platform, such as the commerce management engine 136 of the e-commerce platform 100 shown in FIG. 3. If the transaction analysis engine 310 is implemented at least in part on a device associated with the online service, such as the merchant device 102 shown in FIGS. 1 and 3 or the merchant device 320 shown in FIG. 4, then the information regarding the transaction may be received from an online service platform, such as the e-commerce platform and/or from an off-platform website, such as the merchant's off-platform website 104 shown in FIG. 3. Still another possibility is that the transaction analysis engine 310 is implemented as a stand-alone component or service (e.g., a stand-alone component or service that is external to the e-commerce platform and the merchant's device), in which case the information regarding the transaction may be received from the online service platform and/or from an off-platform website or device associated with the particular online service.

Note that step 802 of FIG. 9 is optional if the method 800 instead begins at step 804.

At step 804 of FIG. 9, the transaction analysis engine 310 generates a first classification for the transaction based on the received information. For example, the first classification may be generated using a first ML model, such as the ML model 332 of FIG. 4, which has been trained on a first data set containing historical transaction data for multiple online services.

In some embodiments, the first classification may be a fraud risk classification indicating a level of fraud risk for the order. The fraud risk classification for the order may be one of a plurality of different fraud risk classifications that each correspond to a different level of fraud risk. The plurality of different fraud risk classifications could include at least a low risk classification, a medium risk classification and a high risk classification, for example.

In some cases, the first data set on which the first ML model is trained may include data records containing transaction-related information for past transactions for the particular online service. For example, in some embodiments the data records may contain order-related information for the past orders for multiple online stores that are each tagged as either fraudulent or non-fraudulent.

At step 806 of FIG. 9, the transaction analysis engine 310 generates a service-specific classification for the transaction based on the received information. For example, the service-specific classification for the transaction may be generated using a service-specific ML model, such as the ML model 334 of FIG. 4, which has been trained on a second data set containing historical transaction data for the particular online service. For example, in some embodiments, the service-specific classification for the transaction may be a store-specific classification for an order received by a particular online store. In such embodiments, the service-specific ML model may be a store-specific ML model that has been trained on a data set containing historical order-related data for past orders for the particular online store. In some implementations, the second data set on which the store-specific ML model is trained is a subset of the first data set on which the first ML model is trained.

The service-specific classification generated for the transaction may correspond to a transaction completion recommendation for the transaction. The transaction completion recommendation for the transaction may be one of a plurality of different transaction completion recommendations. The plurality of different transaction completion recommendations could include at least an accept transaction recommendation and a reject transaction recommendation, for example.

In some cases, the second data set on which the second ML model is trained may include data records containing transaction-related information for past transactions for the particular online service including, for each of the past transactions, information indicating whether the transaction was approved or rejected by the particular online service.

In some implementations, the service-specific classification generated at step 806 in FIG. 9 may be generated based on the first classification generated at 804 in FIG. 9 and at least a subset of the information received at step 802 in FIG. 9. For example, generating the service-specific classification for the transaction at step 806 in FIG. 9 could include inputting the first classification for the order and at least a subset of the received information into the second ML model.

At step 808, the transaction analysis engine 310 transmits, for display on a device associated with the particular online store, classification information for use in determining whether to complete processing of the transaction. In some embodiments, the classification information could include at least the first classification and the service-specific classification for the transaction. In some embodiments, if the transaction analysis engine 310 is implemented as shown in the example system 300 of FIG. 4, transmitting the classification information for display on the merchant device at step 808 of FIG. 9 may involve the processor 310 instructing that the classification information be transmitted through network interface 312 and over the network 318 to merchant device 320, for display on the merchant device 320.

In some embodiments the service-specific classification generated for the transaction at step 806 in FIG. 9 may be a store-specific classification that corresponds to an order fulfillment decision for an order received by a particular online store. In such embodiments, the method 800 may further include automatically processing the order in accordance with the order fulfillment decision indicated by the store-specific classification. This automatic processing may occur before, after or at substantially the same time as the transmission of the classification information at step 808 in FIG. 9. In other embodiments, rather than automatically processing the order in accordance with the order fulfillment decision recommendation generated at step 808, the method 800 may instead include delaying processing of the order for a predetermined time period, and, if no override of the order fulfillment decision recommendation is received within the predetermined time period, the order may be automatically processed in accordance with the order fulfillment decision recommendation after the predetermined time period has elapsed.

In some embodiments where the service-specific classification generated at step 806 of FIG. 9 corresponds to an order fulfillment decision recommendation, transmitting the classification information for display on a device at step 808 of FIG. 9 may involve transmitting the classification information for display as part of a user interface on a merchant device that includes a user-selectable element corresponding to the order fulfillment decision recommendation indicated by the store-specific classification. In such embodiments, the user-selectable element may be selectable by the user to authorize the order fulfillment decision recommendation indicated by the store-specific classification, similar to the highlighted Accept icon 520 shown as part of the fraud analysis user interface 500 of FIG. 6 and the highlighted Cancel icon 722 of the fraud analysis user interface 700 of FIG. 7.

In some embodiments, after transmitting the classification information at step 808, the method 800 may return to step 802, as indicated at 810 in FIG. 9, to await receipt of information regarding another transaction.

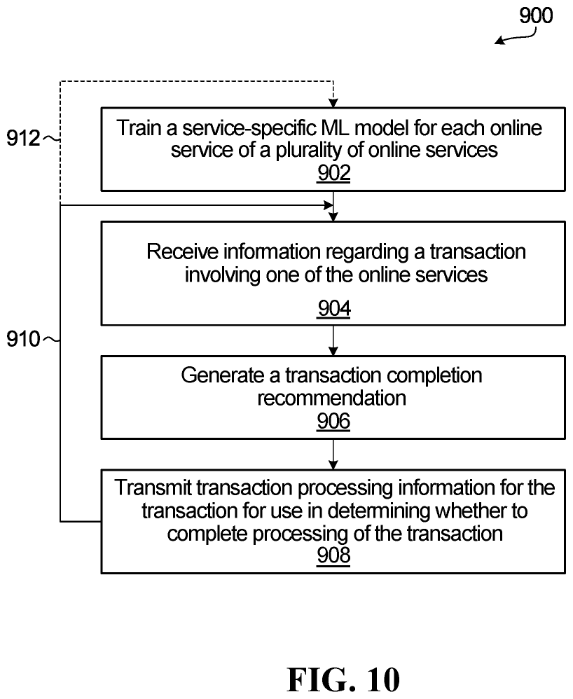

FIG. 10 illustrates a computer-implemented method 900, according to another embodiment. The method 900 may be performed by a computing device (e.g. a processor or combination of processors such as the processor 314 in transaction analysis engine 310). The computing device may be in an online service platform, such as the e-commerce platform 100 of FIG. 3, or, alternatively, may be a stand-alone component or service that is external to an online service platform. In some embodiments, at least a portion of the computer-implemented method could be implemented on a device associated with an online service, such as the merchant device 102 of FIG. 2 or the merchant device 320 of FIG. 4. The method will be described as being performed in transaction analysis engine 310 of FIG. 4, but this is not necessary.

At step 902 of FIG. 10, the transaction analysis engine 310 trains a service-specific ML model for each online service of a plurality of online services. For example, each service-specific ML model may be trained based on a data set containing historical transaction data for the corresponding online service. For example, in some embodiments, the historical transaction data may include information indicating fulfillment decisions for past orders processed by a particular online store. In some cases, for each online service of the plurality of online services, the information indicating fulfillment decisions for past orders processed by the online store includes, for each of the past orders, information indicating whether the order was approved or rejected by a merchant.

At step 904 of FIG. 10, the transaction analysis engine 310 receives information regarding a transaction received by one of the online services. The information regarding the transaction may be received from different locations depending on where the transaction analysis engine 310 is implemented. For example, if the transaction analysis engine 310 is implemented as part of an online service platform, such as an e-commerce platform, then the order-related information may be received from another component of the online service platform, such as the commerce management engine 136 of the e-commerce platform 100 shown in FIG. 3. If the transaction analysis engine 310 is implemented at least in part on a device associated with the particular online service, such as the merchant device 102 shown in FIGS. 1 and 3 or the merchant device 320 shown in FIG. 4, then the information regarding the transaction may be received from the online service platform and/or from an off-platform website, such as the merchant's off-platform website 104 shown in FIG. 3. Still another possibility is that the transaction analysis engine 310 is implemented as a stand-alone component or service that is external to the online service platform and the device associated with the online service, in which case the information regarding the transaction may be received from the online service platform and/or from an off-platform website or device associated with the online service.

At step 906 of FIG. 10, the transaction analysis engine 310 generates a transaction completion recommendation based on the received information regarding the transaction. For example, the transaction completion recommendation for the transaction may be generated using the service-specific ML model corresponding to the online service that received the transaction. In some embodiments, the transaction completion recommendation for the transaction may be one of a plurality of different transaction completion recommendations. The plurality of different transaction completion recommendations could include at least an accept transaction recommendation and a reject transaction recommendation, for example.

At step 908 of FIG. 10, the transaction analysis engine 310 transmits, for display on a device associated with the online service, transaction processing information for use in determining whether to complete processing of the transaction. In some embodiments, the transaction processing information could include at least the transaction completion recommendation for the transaction. In some embodiments, if the transaction analysis engine 310 is implemented as shown in the example system 300 of FIG. 4, transmitting the transaction processing information for display on the merchant device at step 908 of FIG. 10 may involve the processor 310 instructing that the classification information be transmitted through network interface 312 and over the network 318 to merchant device 320, for display on the merchant device 320.

In some embodiments, the transaction processing information for the transaction may further include a fraud risk classification indicating a level of fraud risk for the transaction. The fraud risk classification for the transaction may be one of a plurality of different fraud risk classifications that each correspond to a different level of fraud risk, for example. In such embodiments, the method 900 may further include a step of generating the fraud risk classification for the transaction based on the received information regarding the transaction. For example, the fraud risk classification may be generated using an ML model trained on a data set containing historical transaction-related data for multiple online services as described herein. In some implementations, the transaction completion recommendation generated at step 906 in FIG. 10 may be generated based on the fraud risk classification and at least a subset of the information received at step 904 in FIG. 10. For example, generating the transaction completion recommendation at step 906 in FIG. 10 could include inputting the fraud risk classification for the transaction and at least a subset of the received information into the service-specific ML model corresponding to the online service that received the transaction.

In some embodiments, the method 900 may further include automatically processing the transaction in accordance with the transaction completion recommendation generated for the transaction. This automatic processing may occur before, after or at substantially the same time as the transmission of the transaction processing information at step 908 in FIG. 10. In other embodiments, rather than automatically processing the transaction in accordance with the transaction completion recommendation generated at step 908, the method 900 may instead include delaying processing of the transaction for a predetermined time period, and, if no override of the transaction completion recommendation is received within the predetermined time period, the transaction may be automatically processed in accordance with the transaction completion recommendation after the predetermined time period has elapsed.

In some embodiments, transmitting the transaction processing information at step 908 of FIG. 10 may involve transmitting the transaction processing information for display as part of a user interface on the merchant device that includes a user-selectable element corresponding to the transaction completion recommendation. In such embodiments, the user-selectable element may be selectable by the user to authorize the transaction completion recommendation, similar to the highlighted Accept icon 520 shown as part of the fraud analysis user interface 500 of FIG. 6 and the highlighted Cancel icon 722 of the fraud analysis user interface 700 of FIG. 7.

In some embodiments, after transmitting the transaction processing information at step 908, the method 900 may return to step 904, as indicated at 910 in FIG. 10, to await receipt of information regarding another transaction. In other embodiments, the method 900 may also or instead involve a periodic return to step 902, as indicated at 912 in FIG. 10, and the service-specific ML models may be re-trained, possibly using data sets that have been updated with transaction-related information for transactions processed subsequent to previous training.

In some embodiments, a system to perform the method 800 of FIG. 9 and/or the method 900 of FIG. 10 is provided. The system may include a memory (e.g. memory 316 of FIG. 4) and at least one processor (e.g. processor 314 of FIG. 4). The memory stores the indications and information, and the at least one processor directly performs or instructs operations. For example, with reference to the method 800 of FIG. 9, the at least one processor may directly perform certain operations such as generating a first classification and a service-specific classification for a transaction received by a particular online service (e.g., using the ML models described herein). The at least one processor may instruct certain operations, e.g. instruct that particular information (e.g. classification information or transaction processing information for a transaction) be transmitted to a device associated with an online service. This may occur by the processor retrieving the information to be transmitted and any associated instructions for the device (e.g. instructions indicating how the information is to be displayed), and then sending an instruction to a transmitter to transmit the information and associated instructions to the network address (e.g. IP address) of the device. The transmission is sent through a network interface and over a network and to the device.

### Other Use Cases for Machine Learning in Order Processing

The preceding embodiments are all described in the context of classifying and/or processing transactions received by a particular online online service using a service-specific machine learning model that is trained on historical transaction-related information for past transactions processed by the online service. However, service-specific or user-specific machine learning models are also applicable to other scenarios and use cases.

As one example, a merchant-specific trained ML model may be used to classify a merchant's customers. For example, a store-specific ML model may be trained to learn how a particular merchant classifies their customer for various purposes, such as providing discount offers, loyalty points, tracking returning customers, providing targeted promotions, identifying customers the merchant may be at risk of losing. Merchants have tried to implement rule-based flows to segment customers into different groups but their rule-based classifications often do not scale easily to deal with larger/more diverse populations of customers and/or larger/more diverse product offerings. A merchant-specific ML model, once trained, may recommend and/or automatically carry out certain actions with respect to those customers it has designated certain classifications. For example, the merchant-specific ML model may be trained on a data set that includes data records relating to past discount offers that were provided to certain classification(s) of customers (e.g., customers identified as being “preferred” customers on the basis that they have placed at least a threshold number of past orders and/or whose past orders total at least a threshold amount) and the resulting orders that were received that took advantage of the discount offer. Based on this training data the ML model may be trained to group or classify customers and provide targeted discounts to the customer class(es)/group(s) in a manner that may be more likely to increase sales/revenue and/or avoid the loss of customers.

As another example, group-specific ML models may be used for different defined groups of merchants. For example, certain merchants may have certain similarities, such as product offerings, common geographic regions of operation, target markets, size (revenues, number of sales), etc., and therefore could potentially be segmented into groups on that basis. Depending on the nature of the groupings, the groups may not be mutually exclusive (there may be overlap between groups). The group-specific ML models for each of the groups may then be trained based on historical order data for the merchants in the group and, once trained, may be used to generate group-specific recommendations/classifications for the merchants in the group. For example, rather than using a common ML model that has been trained based on historical order data for a wider population of merchants, the general fraud risk level that is assessed for an order received by a merchant in a particular group may be generated using the group-specific ML model trained based on the historical order data for merchants within that group. If a particular merchant is a member of multiple groups, then multiple group-specific classifications/recommendations may be generated using the various group-specific ML models corresponding to the various groups to which the particular merchant belongs. The various group-specific classifications/recommendations may be conveyed separately to the merchant or in some cases could possibly be combined into a meta-classification/meta-recommendation. Such a meta-classification/meta-recommendation may be generated using a stacked or ensemble learning ML model, for example.

### CONCLUSION

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions, and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor-readable storage medium or media for storage of information, such as computer/processor-readable instructions, data structures, program modules, and/or other data. A non-exhaustive list of examples of non-transitory computer/processor-readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor-readable storage media.

1. A computer-implemented method comprising:
receiving information regarding a transaction received by a particular online service;
generating, using a first machine learning (ML) model trained on a first data set containing historical transaction data for multiple online services, a first classification for the transaction based on the received information regarding the transaction;
generating, using a second ML model trained on a second data set containing historical transaction data for the particular online service, a service-specific classification for the transaction based on the received information regarding the transaction; and
transmitting, for display on a device associated with the particular online service, classification information for the transaction, the classification information including at least the first classification and the service-specific classification for use in determining whether to complete processing of the transaction.

2. The computer-implemented method of claim 1, wherein the service-specific classification generated for the transaction corresponds to a transaction completion recommendation for the transaction, the transaction completion recommendation for the transaction being one of a plurality of different transaction completion recommendations.

3. The computer-implemented method of claim 2, wherein the plurality of different transaction completion recommendations include at least an accept transaction recommendation and a reject transaction recommendation.

4. The computer-implemented method of claim 1, wherein the second data set containing historical transaction data for the particular online service comprises data records containing transaction-related information for past transactions for the particular online service including, for each of the past transactions, information indicating whether the transaction was approved or rejected by the particular online service.

5. The computer-implemented method of claim 2, wherein:
the particular online service comprises a particular online store associated with a merchant account;
receiving information regarding a transaction received by the particular online service comprises receiving order-related information for an order placed with the particular online store;
the first data set on which the first ML model is trained contains historical order-related data for past orders for multiple online stores;
generating a first classification for the transaction comprises generating, using the first ML model, a first classification for the order based on the received order-related information;
the second data set on which the second ML model is trained contains historical order-related data for past orders for the particular online store;
generating a service-specific classification for the transaction comprises generating, using the second ML model, a store-specific classification for the order based on the received order-related information; and
transmitting classification information for the transaction comprises transmitting, for display on a merchant device associated with the merchant account, classification information for the order, the classification information for the order including at least the first classification and the store-specific classification for use in determining whether to complete processing of the order.

6. The computer-implemented method of claim 5, wherein the first classification generated for the order corresponds to a fraud risk classification indicating a level of fraud risk for the order, the fraud risk classification for the order being one of a plurality of different fraud risk classifications that each correspond to a different level of fraud risk.

7. The computer-implemented method of claim 6, wherein the first data set containing historical order-related data for past orders for multiple online stores comprises data records containing order-related information for the past orders for multiple online stores that are each tagged as either fraudulent or non-fraudulent.

8. The computer-implemented method of claim 6, wherein generating the store-specific classification for the order based on the received order-related information comprises inputting the first classification for the order and at least a subset of the received order-related information into the second ML model.

9. The computer-implemented method of claim 6, wherein the second data set is a subset of the first data set.

10. The computer-implemented method of claim 6, wherein the store-specific classification generated for the order corresponds to an order fulfillment decision, the method further comprising automatically processing the order in accordance with the order fulfillment decision indicated by the store-specific classification.

11. The computer-implemented method of claim 6, wherein the transaction completion recommendation for the transaction corresponds to an order fulfillment decision recommendation for the order, the method further comprising:
delaying processing of the order for a predetermined time period; and
if no override of the order fulfillment decision recommendation is received within the predetermined time period, automatically processing the order in accordance with the order fulfillment decision recommendation after the predetermined time period has elapsed.

12. The computer-implemented method of claim 2, wherein transmitting the classification information comprises transmitting the classification information for display as part of a user interface that includes a user-selectable element corresponding to the transaction completion recommendation indicated by the service-specific classification, the user-selectable element being selectable to authorize the transaction completion recommendation indicated by the service-specific classification.

13. A system comprising:
a memory to store: a first machine learning (ML) model trained on a first data set containing historical transaction data for multiple online services; and a second ML model trained on a second data set containing historical transaction data for a particular online service;
at least one processor to:
generate, using the first ML model, a first classification for a transaction received by the particular online service based on transaction information regarding the transaction;
generate, using the second ML model, a service-specific classification for the transaction based on the transaction information; and
instruct transmission, for display on a device associated with the online service, classification information for the transaction, the classification information including at least the first classification and the service-specific classification for use in determining whether to complete processing of the transaction.

14. The system of claim 13, wherein the service-specific classification generated for the transaction corresponds to a transaction completion recommendation for the transaction, the transaction completion recommendation for the transaction being one of a plurality of different transaction completion recommendations.

15. The system of claim 14, wherein the plurality of different transaction completion recommendations include at least an accept transaction recommendation and a reject transaction recommendation.

16. The system of claim 13, wherein the second data set comprises data records containing transaction-related information for past transactions for the particular online service including, for each of the past transactions, information indicating whether the transaction was approved or rejected by the particular online service.

17. The system of claim 14, wherein:
the particular online service comprises a particular online store associated with a merchant account;
the transaction received by the particular online service comprises an order placed with the particular online store;
the first data set on which the first ML model is trained contains historical order-related data for past orders for multiple online stores;
generating a first classification for the transaction based on transaction information regarding the transaction comprises generating, using the first ML model, a first classification for the order based on order-related information;
the second data set on which the second ML model is trained contains historical order-related data for past orders for the particular online store;
generating a service-specific classification for the transaction based on transaction information regarding the transaction comprises generating, using the second ML model, a store-specific classification for the order based on the order-related information; and
transmitting classification information for the transaction comprises transmitting, for display on a merchant device associated with the merchant account, classification information for the order, the classification information including at least the first classification and the store-specific classification for use in determining whether to complete processing of the order.

18. The system of claim 17, wherein the first classification generated for the order corresponds to a fraud risk classification indicating a level of fraud risk for the order, the fraud risk classification for the order being one of a plurality of different fraud risk classifications that each correspond to a different level of fraud risk.

19. The system of claim 18, wherein the first data set comprises data records containing order-related information for the past orders for multiple online stores that are each tagged as either fraudulent or non-fraudulent.

20. The system of claim 18, wherein the at least one processor is to generate, using the second ML model, the store-specific classification for the order based on the first classification for the order and at least a subset of the order-related information.

21. The system of claim 18, wherein the second data set is a subset of the first data set.

22. The system of claim 18, wherein the store-specific classification generated for the order corresponds to an order fulfillment decision, and wherein the at least one processor is further to automatically process the order in accordance with the order fulfillment decision indicated by the store-specific classification.

23. The system of claim 18, wherein the transaction completion recommendation for the transaction corresponds to an order fulfillment decision recommendation for the order, and wherein the processor is further to:
delay processing of the order for a predetermined time period; and
if no override of the order fulfillment decision recommendation is received within the predetermined time period, automatically process the order in accordance with the order fulfillment decision recommendation after the predetermined time period has elapsed.

24. The system of claim 14, wherein the at least one processor is to instruct transmission of the classification information for display as part of a user interface that includes a user-selectable element corresponding to the transaction fulfillment decision recommendation indicated by the service-specific classification, the user-selectable element being selectable to authorize the transaction fulfillment decision recommendation indicated by the service-specific classification.
